(19) United States
(12) Patent Application Publication
(10) Pub. No.: US 2006/0286990 A1
(43) Pub. Date: Dec. 21, 2006

(54) Message validity determining method to determine whether an information equipment is indeed connected to a wireless network

(75) Inventors: Teng-Huei Juan, Hsin Chu (TW); Chao-Yang Lee, Hsin Chu (TW)

Correspondence Address: EDWARDS & ANGELL, LLP, P.O. BOX 55874, BOSTON, MA, 02205, US

(73) Assignee: RDC Semiconductor Co., Ltd., Hsin Chu (TW)

(21) Appl. No.: 11/267,114

(22) Filed: Nov. 3, 2005

(30) Foreign Application Priority Data
Jun. 16, 2005 (TW) 094119956

(51) Int. Cl. H04Q 7/20

(52) U.S. Cl. 455/466

(57) ABSTRACT

A message validity determining method is applied to a wireless network for allowing a user to know whether a connection-established message emitted by a wireless base station are correct after the user has input an encryption parameter in an information equipment and the information equipment has been connected to the wireless network. When receiving the connection-established message, the information equipment emits a testing message to the wireless base station. If the wireless base station replies with a test-replying message, the information equipment is determined to be connected to the wireless base station. Therefore, validity of the connection-established message is determined according to a mechanism of whether the wireless base station replies with the test-replying message after receiving the testing message, so that subsequent operations can be properly taken, such that the user is not confused or misled by simply receiving the connection-established message from the wireless base station.

### FIELD OF THE INVENTION

The present invention relates to a message validity determining method, and more particularly, to a message validity determining method applied in a wireless network to determine whether an information equipment is indeed connected to the wireless network.

### BACKGROUND OF THE INVENTION

Wireless Local Area Networks (WLANs) connect various kinds of local area network apparatus, such as Personal Computers (PCs), hubs, or switches etc. via wireless radio frequency (RF), and provide sharing of digital data between different local area networks, eliminating the need for layout of electrical lines and providing roaming users network environments anytime and anywhere.

Normally, the coverage area of a WLAN depends on openness of the environment. Without the provision of an external antenna, the coverage area is about 250 meters. If the space is half opened with some level of blocking, the coverage area is about 35-50 meters, the distance of which increases if an antenna is added. Along the maturity of network related technologies and network protocols, wireless communication networks are widely employed for convenient purpose. For an application of a standard wireless communication network, users only needs to have/insert a wireless network card in a information equipment (e.g. a desktop computer, a notebook computer, a pocket computer, a PDA or a mobile phone etc.) with a WLAN interface and installs an Access Point (AP) at the region requiring access to the network, thereafter the user can freely move in that region while still connected to the network.

A WLAN using the IEEE 802.11 standard allows the users to have information equipment equipped with a wireless network card, in order to wirelessly connect to the network within the effective area of a wireless base station (a access point). Since the development of the WLANs, application of the WLANs has always been a popular topic. In Taiwan, there are already numerous public places that provide wireless network connections. Many network providers also provide packages or monthly schemes of wireless connection for homes to suit the demands of the market. Although it is convenient to use a WLAN for connecting to a network, its data transmission security is in doubt. For example, if you are using a WLAN to connect to the Internet, your neighbors may easily access your WLAN to connect to the Internet and your shared files without your permission. Such situation is even worse for enterprises. Thus, in order to solve the security problem of WLANs, apart from setting a password, Wired Equivalent Privacy (WEP) is a common security protocol for current WLANs. WEP encrypts data to be transmitted, and a receiving end has to have the same key used at the transmitting end in order to decrypt the received data. Thus, even if the data is eavesdropped by a third person, there is no way to decrypt the data unless he/she has got the key. This data security method usually requires an authenticating mechanism to validate the secret keys.

Another kind of WLAN data encryption technology called WPA (Wi-Fi Protected Access) is proposed by Wi-Fi Alliance, it is similar to the WEP and only differs in the manner in which the secret key is generated. WPA allows clients to set/change their own authenticating passwords with a back-end LAN of a wireless base station (access point) at any time.

Besides the two data security technologies described above, which performs encryption key authentication, the encryption parameters adopted in other kinds of data security technologies (e.g. OPEN+WEP, WPAPSK-AES, WPAPSK-TKIP etc.) are unauthenticated. That is, when a user chooses to connect to the WLAN using an unauthenticated mechanism, even if the encryption parameter inputted is different from that stored in the wireless base station (access point), such as in the case of the user entered the wrong encryption key, a network-connected message will still be sent back from the wireless base station to the user. However, due to a mismatch of the encryption parameters, the user is not actually connected to the WLAN. At this point, the user will be confused as a result of the received message indicating that a WLAN connection has already been made.

Thus, there is a need in this field to provide a method of determining the validity of received messages indicating established network connections.

### SUMMARY OF THE INVENTION

In the light of forgoing drawbacks, an objective of the present invention is to provide a message validity determining method for allowing users to properly perform subsequent operations.

Another objective of the present invention is to provide a message validity determining method so as to prevent the users from being misled by a connection-established message emitted by the wireless base station.

In accordance with the above and other objectives, the present invention discloses a message validity determining method. The method allows an information equipment to emit a testing message to a wireless base station upon receiving a connection-established message emitted by the wireless base station. If the wireless base station replies with a test-replying message, the information equipment is determined to be indeed connected to the wireless base station.

Compared with the prior art, the present invention determines whether the test-replying message is emitted by the wireless base station after the wireless base station receives the testing message, so as to determine the accuracy of the connection-established message. Therefore, the user can perform subsequent operations and will not misled by the connection-established message emitted by the wireless base station.

### BRIEF DESCRIPTION OF THE DRAWINGS

The present invention can be more fully understood by reading the following detailed description of the preferred embodiments, with reference made to the accompanying drawings, wherein:

FIG. 1 is flowchart of a message validity determining method of the preferred embodiment according to the present invention; and

FIGS. 2(A) to 2(F) are schematic block diagrams showing operations of the message validity determining method according to the present invention.

### DETAILED DESCRIPTION OF THE EMBODIMENTS

The present invention is described by the following specific embodiments. Those with ordinary skills in the arts can readily understand the other advantages and functions of the present invention after reading the disclosure of this specification. The present invention can also be implemented with different embodiments. Various details described in this specification can be modified based on different viewpoints and applications without departing from the scope of the present invention.

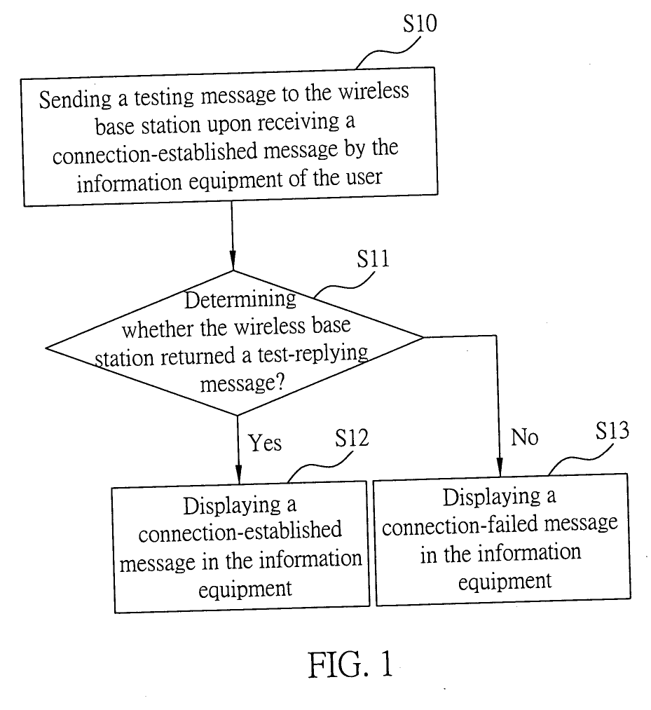

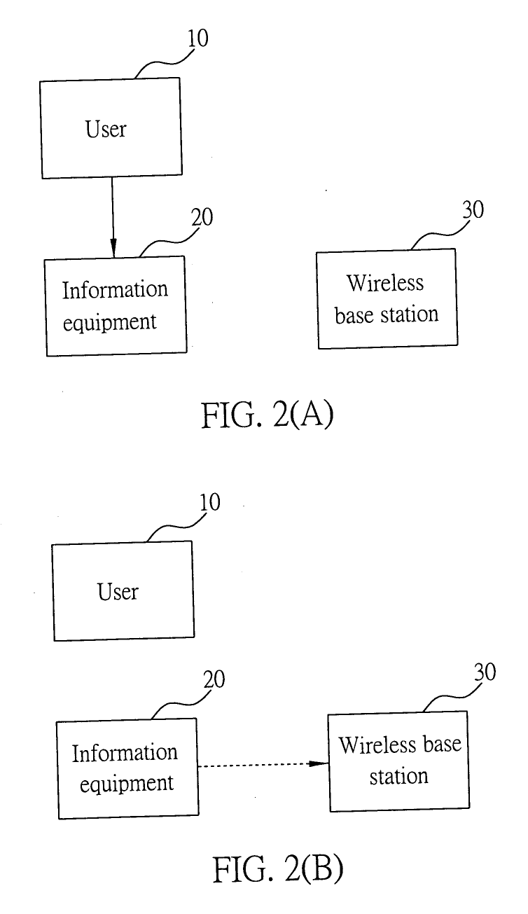

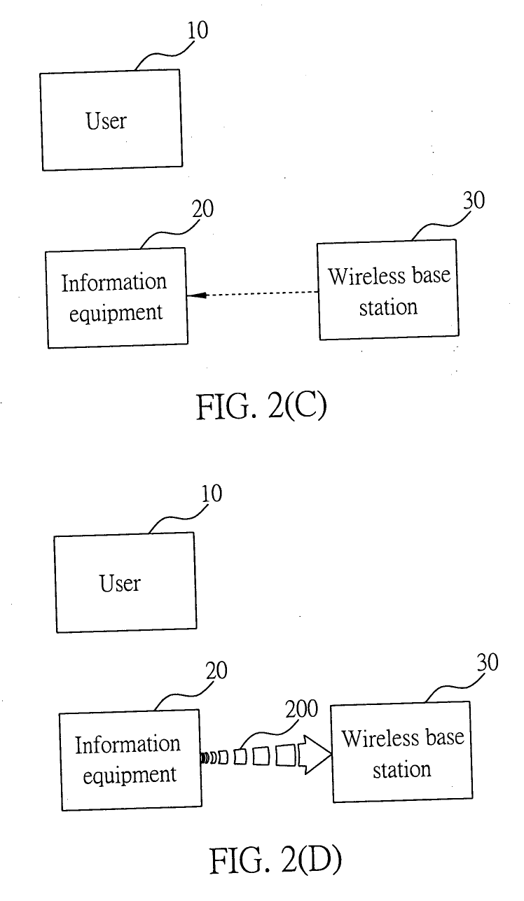

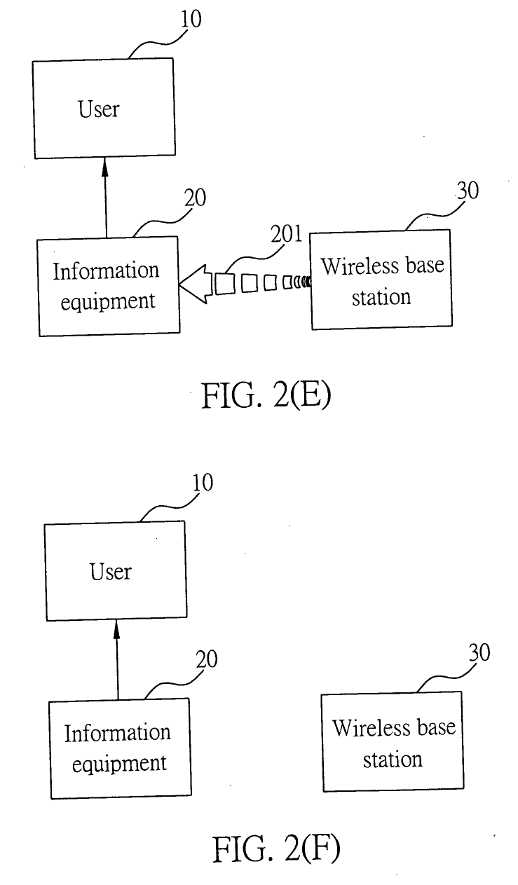

FIGS. 1, 2(A) to 2(F) illustrate schematic block diagrams related to a message validity determining method of the preferred embodiment according to the present invention. The message validity determining method of the present invention is described in conjunction with the drawings. It should be noted that the drawings are simplified schematic diagrams for illustrating the basic structures related to the present invention. Therefore the drawings only show elements and descriptions related to the present invention. The actual layout of the elements may be more complicated.

Please refer to FIG. 1, which is a flow chart of the message validity determining method of the present invention. The method is applied to a wireless network for allowing a user to input related encryption parameters to an information equipment equipped with a wireless network card. After the information equipment is connected to the wireless network, the method determines the validity of a message sent by a wireless base station in order for the user to carry out subsequent processes. The wireless network is a Wireless Local Area Network (WLAN), and the information equipment is one selected from the group consisting of a hand-held computer, a desktop computer, a notebook computer, a PC, a super computer, a server, a PDA, a mobile phone, or a game console with internal processing unit or internal processing mechanism. Additionally, the wireless base station is a wireless router or an Access Point (AP). In a case that the wireless base station is a wireless router, a message decoding device is built in the wireless router. The message decoding device is a dynamic host configuration protocol decoding module. In another case that the wireless base station is an access point, the access point has to be connected to a message decoding device, which is a Dynamic Host Configuration Protocol (DHCP) server.

Before the method of the present invention is executed, please refer to FIG. 2(A) in advance. FIG. 2(A) shows that a user 10 inputs encryption parameters required for wireless network connection to an information equipment 20. Then, in FIG. 2(B), a request for wireless network connection is sent to a wireless base station 30. Thereafter, in FIG. 2(C), upon receiving (regardless of whether an authentication mechanism is used) the request for wireless network connection, the wireless base station 30 returns a connection-established message back to the information equipment 20. The encryption parameters described above comprises for example an authentication type, an encryption type and an encryption key etc. These three encryption parameters are related techniques and can be readily understood by those with ordinary skills in the art, further description hereby omitted.

The following describes the message validity determining method of the present invention. Firstly, as shown in step S10 of FIG. 1, upon receiving the connection-established message, the information equipment 20 emits a testing message to the wireless base station 30. More specifically, after the information equipment 20 receives the connection-established message returned by the wireless base station 30 through the wireless network, and after the information equipment 20 had informed the user 10 of the message to indicate that the information equipment 20 has been connected to the wireless network (for example the method displays information about the connection-established message on a display unit of the information equipment 20, such as a display screen or light), the user controls the information equipment 20 manually to emit a testing message over an Internet Protocol Layer to the wireless base station 30, as shown in FIG. 2(D). Alternatively, after receiving the connection-established message returned by the wireless base station 30 through the wireless network, the information equipment 20 emits a testing message over the Internet Protocol Layer automatically to the wireless base station 30. The testing message is a DHCP testing message. Proceed to step S11.

In step S11, determining whether the wireless base station returns a test-replying message. After the user manually controls the information equipment to emit the testing message to the wireless base station or the information equipment emits the testing message to the wireless base station automatically, determining whether the wireless base station returns a test-replying message within a predetermined time. If the wireless base station returns a test-replying message within the predetermined time, then proceed to step S12; or else if the wireless base station has not returned a test-replying message after the predetermined time has passed, then proceed to step S13. The test-replying message is a Dynamic Host Configuration Protocol test-replying message. The predetermined time can be set by the user or by the information equipment automatically.

Step S12 includes displaying a connection message on the information equipment. Please refer to FIG. 2(E) concurrently. In step S12, since the wireless base station 30 returns a test-replying message within the predetermined time, the information equipment 20 then display the connection message on the display unit (such as a display screen or indicator etc. (not shown)), informing the user 10 that the information equipment 20 is indeed connected to the wireless network. Thereafter, the user 10 can perform subsequent operations such as connecting to Internet. It should be noted that displaying the connection message on the display unit is just one embodiment for the information equipment 20 to notify the user 10. The message validity determining method is not limited to this type of notification, but can be performed by other methods such as sound etc.

Step S13 includes displaying a non-connection message on the information equipment. Please refer to FIG. 2(F) concurrently. In step S13, since the wireless base station 30 does not return the test-replying message after the predetermined time has passed, the information equipment 20 then displays a non-connection message on the display unit (such as a display screen or indicator etc. (not shown)), to inform the user 10 that the information equipment 20 is not connected to the wireless network. That is, the previous connection-established message returned by the wireless base station is an error message. After the user 10 or the information equipment 20 is notified, error elimination processes can be subsequently taken manually by the user or automatically by the information equipment. It should be noted that displaying the non-connection message on the display unit is just one embodiment for the information equipment 20 to notify the user 10. The message validity determining method is not limited to this type of notification, but can be performed by other methods such as sound etc.

From the above descriptions and diagrams, the technical features and embodiments of the present invention can be clearly understood. The message validity determining method of the present invention comprises emitting the testing message to the wireless base station after receiving the connection-established message from the wireless base station, and if a test-replying message is returned by the wireless base station, then the information equipment is verified to be connected to the wireless base station as well as the wireless network. Therefore, the present invention validates the connection-established message by the mechanism of sending a testing message to the wireless base station and determining whether a test-replying message is returned by the wireless base station. Thereby, the user is avoided of the situation of receiving a connection-established message sent by the wireless base station while actually no successful connection is established between the wireless base station and the information equipment, and so that subsequent operations can be taken based on the actual current situation.

The above embodiments are only used to illustrate the principles of the present invention, and they should not be construed as to limit the present invention in any way. The above embodiments can be modified by those with ordinary skills in the arts without departing from the scope of the present invention as defined in the following appended claims.

What is claimed is:

1. A message validity determining method applicable to a wireless network for allowing a user to know whether a connection-established message emitted by a wireless base station are correct after the user inputs an encryption parameter in an information equipment and the information equipment is connected to the wireless network, the method comprising:
utilizing the information equipment to receive the connection-established message;
utilizing the information equipment to emit a testing message to the wireless base station;
providing the wireless base station with a message decoding device used to decode the testing message; and
determining if the wireless base station returns a test-replying message to indicate that the information equipment is indeed connected to the wireless network.

2. The message Validity determining method of claim 1, wherein the information equipment emits the testing message over an Internet Protocol Layer.

3. The message validity determining method of claim 1, wherein the testing message is a Dynamic Host Configuration Protocol (DHCP) testing message.

4. The message validity determining method of claim 1, wherein the test-replying message is sent by the wireless base station at an Internet Protocol Layer.

5. The message validity determining method of claim 1, wherein the test-replying message is a DHCP test-replying message.

6. The message validity determining method of claim 1, wherein the wireless network is a Wireless Local Area Network (WLAN).

7. The message validity determining method of claim 1, wherein the information equipment comprises a wireless network card.

8. The message validity determining method of claim 1, wherein the information equipment is one selected from the group consisting of a palmtop computer, a desktop computer, a notebook computer, a personal computer, a super computer, a server computer, a Personal Digital Assistant (PDA), a cellular phone, and a game device with an embedded computer processing mechanism or externally connected to a computer processing device.

9. The message validity determining method of claim 1, wherein the encryption parameter is one selected from the group consisting of an authentication-type, an encryption-type and an encryption key.

10. The message validity determining method of claim 1, wherein the wireless base station is one selected from the group consisting of a wireless router and an access point (AP).

11. The message validity determining method of claim 10, wherein the message decoding device is built in the wireless router..

12. The message validity determining method of claim 11, wherein the message decoding device is a DHCP decoding module..

13. The message validity determining method of claim 10, wherein the message decoding device is connected to the access point.

14. The message validity determining method of claim 13, wherein the message decoding device is a DHCP server.

15. A message validity determining method applicable to a wireless network for allowing a user to know whether a connection-established message emitted by a wireless base station are correct after the user has input an encryption parameter in an information equipment and the information equipment has been connected to the wireless network, the method comprising:
(1) upon receiving the connection-established message, the information equipment emitting a testing message to the wireless base station, the wireless base station having a message decoding device;
(2) determining whether the wireless base station returned a test-replying message to the information equipment within a predetermined time, if so, proceeding to step (3), and else proceeding to step (4);
(3) displaying a connection message on the information equipment to inform the user that the the wireless network is indeed connected to the wireless network; and
(4) displaying a non-connection message on the information equipment to inform the user that the information equipment is actually not connected to the wireless network.

16. The message validity determining method of claim 15, wherein the information equipment emits the testing message over an Internet Protocol Layer.

17. The message validity determining method of claim 15, wherein the testing message is a DHCP testing message.

18. The message validity determining method of claim 15, wherein the wireless base station emits the test-replying message over an Internet Protocol Layer.

19. The message validity determining method of claim 15, wherein the test-replying message is a DHCP test-replying message.

20. The message validity determining method of claim 15, wherein the predetermined time is set by the user or the information equipment.

21. The message validity. determining method of claim 15, wherein the wireless network is a WLAN.

22. The message validity determining method of claim 15, wherein the information equipment comprises a wireless network card.

23. The message validity determining method of claim 15, wherein the information equipment is one selected from the group consisting of a palmtop computer, a desktop computer, a notebook computer, a personal computer, a super computer, a server computer, a PDA, a cell phone, and a game device with a built-in computer processing mechanism or externally connected to a computer processing device.

24. The message validity determining method of claim 15, wherein the encryption parameter is one selected from the group consisting of an authentication-type, an encryption-type and an encryption key.

25. The message validity determining method of claim 15, wherein the wireless base station is one selected from the group consisting of a wireless router and an AP.

26. The message validity determining method of claim 25, wherein the message decoding device is built in the wireless router.

27. The message validity determining method of claim 26, wherein the message decoding device is a DHCP decoding module.

28. The message validity determining method of claim 25, wherein the message decoding device is connected to the AP.

29. The message validity determining method of claim 28, wherein the message decoding device is a DHCP server.
